(19) United States
(12) Patent Application Publication
(10) Pub. No.: US 2026/0274265 A1
(43) Pub. Date: Sep. 17, 2026

(54) METHOD AND APPARATUS FOR CONTROLLING LANE CHANGE OF AUTONOMOUS VEHICLE

(71) Applicants: Hyundai Motor Company, Seoul (KR); Kia Corporation, Seoul (KR)

(72) Inventors: Wi Han PARK, Hwaseong-Si (KR); Young Bin MIN, Hwaseong-Si (KR); Jong Sung PARK, Hwaseong-Si (KR); Moon Hyung SONG, Cheonan-si (KR)

(21) Appl. No.: 19/391,140

(22) Filed: Nov. 17, 2025

(30) Foreign Application Priority Data
Mar. 12, 2025 (KR) 10-2025-0032015

(51) Int. Cl. B60W 30/18; B60W 30/12; B60W 60/00; H04W 4/40

(52) U.S. Cl. CPC B60W 30/18163; B60W 30/12; B60W 60/001; H04W 4/40; B60W 2554/4042; B60W 2554/406; B60W 2556/45

(57) ABSTRACT

An apparatus for an autonomous vehicle comprises a sensor configured to detect an object around the autonomous vehicle; a communication interface configured to communicate with an external device; and/or a processor configured to control an autonomous driving controller, wherein the processor may: generate external environment data, determine whether a current lane in which the autonomous vehicle is driving is an optimal lane, create a lane change strategy including an expected number of lane changes, cause the autonomous driving controller to control the autonomous vehicle to change a lane once and move to a changed current lane, determine whether the autonomous vehicle has changed lanes as many times as the expected number of lane changes, determine whether the lane change strategy is valid in the changed current lane, and cause the autonomous driving controller to control autonomous driving of the autonomous vehicle.

### CROSS-REFERENCE TO RELATED APPLICATION

This application claims the benefit of and priority to Korean Patent Application No. 10-2025-0032015, filed on Mar. 12, 2025, the entire disclosure(s) of which is hereby incorporated herein by reference in its entirety.

### TECHNICAL FIELD

The present disclosure relates to a method and apparatus for controlling a lane change of an autonomous vehicle.

### BACKGROUND

The content described hereinbelow merely provides background information on the present disclosure and does not constitute the prior art.

In the field of the autonomous driving control or driver assistance control of a vehicle, various technologies have been developed to maintain a lane in which the vehicle is driving or to change lanes.

The criteria for determining whether the vehicle maintains its current lane or changes lanes may include constraints such as path planning to reach a destination and/or compliance with laws.

However, in addition to these constraints, appropriate control is also needed to maintain the lane in which the vehicle is driving or to change lanes for more efficient autonomous driving control or driver assistance control.

### SUMMARY

In view of the above, a method and apparatus for controlling a lane change of an autonomous vehicle may enable efficient driving through active lane changes while ensuring the driving safety of the vehicle.

The objectives to be achieved by the present disclosure are not limited to the above-mentioned objectives, and other objectives which are not mentioned will be clearly understood by those skilled in the art from the following description.

According to the present disclosure, an apparatus for an autonomous vehicle, the apparatus comprising: a sensor configured to detect an object around the autonomous vehicle; a communication interface configured to communicate with an external device; and processor configured to control an autonomous driving controller, wherein the processor is configured to: generate, based on at least one of sensor data generated by the sensor and communication data collected by the communication interface, external environment data; determine, using the external environment data, whether a current lane in which the autonomous vehicle is driving is an optimal lane; create, based on determining that the current lane in which the autonomous vehicle is driving is not the optimal lane, a lane change strategy including an expected number of lane changes; cause, based on the lane change strategy, the autonomous driving controller to control the autonomous vehicle to change a lane once and move to a changed current lane; determine whether the autonomous vehicle has changed lanes as many times as the expected number of lane changes; determine, based on determining that the autonomous vehicle has not changed lanes as many times as the expected number of lane changes, whether the lane change strategy is valid in the changed current lane; and cause, based on whether the lane change strategy is valid in the changed current lane, the autonomous driving controller to control autonomous driving of the autonomous vehicle.

According to the present disclosure, a method performed by an autonomous vehicle, the method comprising: generating, based on at least one of sensor data generated by a sensor of the autonomous vehicle and communication data collected by a communication interface of the autonomous vehicle, external environment data; determining, using the external environment data, whether a current lane in which the autonomous vehicle is driving is an optimal lane; creating, based on determining that the current lane in which the autonomous vehicle is driving is not the optimal lane, a lane change strategy including an expected number of lane changes; causing, based on the lane change strategy, an autonomous driving controller of the autonomous vehicle to control the autonomous vehicle to change a lane once and move to a changed current lane; determining whether the autonomous vehicle has changed lanes as many times as the expected number of lane changes; determining, based on determining that the autonomous vehicle has not changed lanes as many times as the expected number of lane changes, whether the lane change strategy is valid in the changed current lane; and causing, based on whether the lane change strategy is valid in the changed current lane, the autonomous driving controller to control autonomous driving of the autonomous vehicle.

### ADVANTAGEOUS EFFECTS

A method and apparatus for controlling a lane change of an autonomous vehicle according to an example have the effect of enabling efficient driving through active lane changes while ensuring the driving safety of the vehicle.

### BRIEF DESCRIPTION OF THE DRAWINGS

FIG. 1 is a functional block diagram illustrating an apparatus for controlling a lane change of an autonomous vehicle.

FIG. 2 is a flowchart illustrating a method for controlling a lane change of an autonomous vehicle.

FIG. 3 is a detailed step flowchart of S220.

FIG. 4A is a diagram showing a smooth traffic flow.

FIG. 4B is a diagram showing a cluster traffic flow.

FIG. 4C is a diagram showing a congested traffic flow.

FIG. 5 is a block diagram schematically showing an exemplary vehicle system.

### DETAILED DESCRIPTION

Hereinafter, examples of the present disclosure are described in detail with reference to the accompanying drawings. In the following description, like reference numerals designate like elements, although the elements are shown in different drawings. Further, in the following description of some examples, a detailed description of known functions and configurations incorporated therein has been omitted for the purpose of clarity and for brevity.

Additionally, various terms such as first, second, A, B, (a), (b), etc., are used solely to differentiate one component from the other but not to imply or suggest the substances, order, or sequence of the components. Throughout the present disclosure, when a part ‘includes’ or ‘comprises’ a component, the part is intended to further include other components and not intended to exclude other components unless specifically stated to the contrary. The terms such as ‘unit,’ ‘module,’ and the like refer to one or more units for processing at least one function or operation, which may be implemented by hardware, software, or a combination thereof.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules,” or “units” or further divided into additional components, “modules,” or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random-access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

Each element of the apparatus or method in accordance with the present disclosure may be implemented in hardware, software, and/or a combination of hardware and software. The functions of the respective elements may be implemented in software, and a microprocessor may be implemented to execute the software functions corresponding to the respective elements. When a controller, module, component, device, element, or the like of the present disclosure is described as having a purpose or performing an operation, function, or the like, the controller, module, component, device, element, or the like may be considered herein as being “configured to” meet that purpose or to perform that operation or function. Each controller, module, component, device, element, and the like may separately embody or be included with a processor and a memory, such as a non-transitory computer readable media, as part of the apparatus.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B.

In an example of the present disclosure, although the description is based on right-hand traffic (RHT), a lane change apparatus 100 according to an example of the present disclosure may also be applied to left-hand traffic (LHT).

The terms used herein may be defined as follows.

A vehicle may be equipped with an automated driving system (ADS) and thus may be autonomously driven. For example, the vehicle may perform at least one of steering, acceleration, deceleration, lane change, braking or stopping without a driver's manipulation by the ADS. The ADS may include, for example, at least one of pedestrian detection and collision mitigation system (PDCMS), lane change decision aid system (LCAS), lane departure warning system (LDWS), adaptive cruise control (ACC), lane keeping assistance system (LKAS), road boundary departure prevention system (RBDPS), curve speed warning system (CSWS), forward vehicle collision warning system (FVCWS), or low speed following (LSF).

A user (or a driver) may be a person who uses a vehicle and is provided with a service of an autonomous driving system.

A vehicle control authority (or a vehicle control right) may control at least one component of the vehicle and/or at least one function of the vehicle. The function of the vehicle may include at least one of a steering function, an acceleration function, a deceleration function, a braking function, a lane change function, a line detection function, a lateral control function, an object (or an obstacle) recognition and distance detection function, a powertrain control function, a safety zone detection function, an engine on/off function, a power on/off function, or a vehicle lock/unlock function. The listed functions of the vehicle are merely examples for understanding, and examples of the present disclosure are not limited thereto.

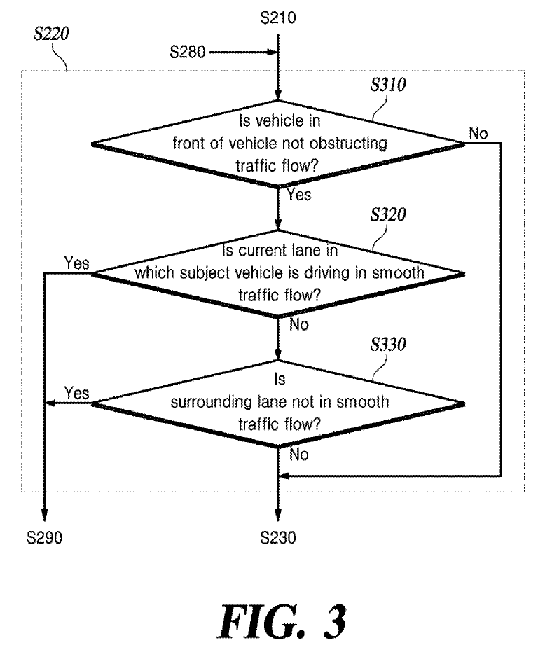

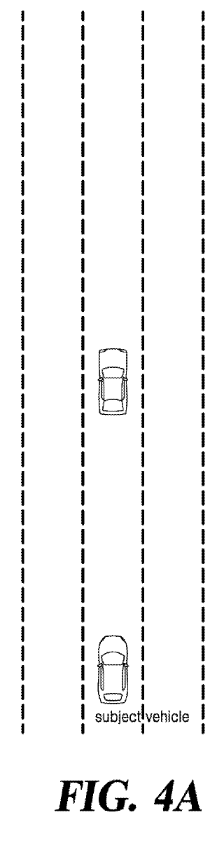

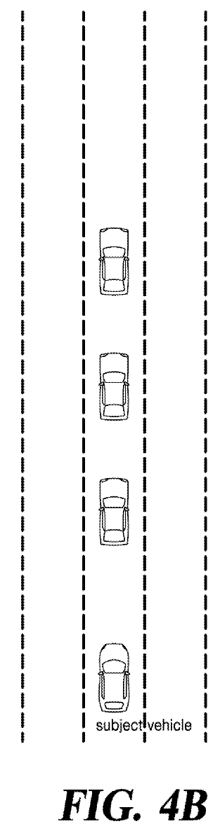

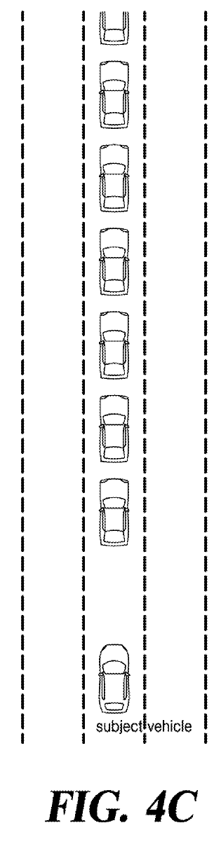

A lane is an area of a road where a vehicle is driven, and may refer to a space divided so that a vehicle is driven in a line. For example, FIGS. 3 and 4 illustrate four lanes (lane 1 to lane 4), which are merely examples for understanding. The number, width, shape and type of lanes that may be applied to the apparatus 100 according to an example of the present disclosure are not limited to the drawings.

A current lane may refer to a lane in which a vehicle is driving in real time. For example, when an autonomous vehicle, which is a subject vehicle, is driving on lane 2, the current lane for the subject vehicle is lane 2.

An adjacent lane may be a lane that meets the current lane. For example, in a road with a plurality of lanes, when the current lane is lane 1, the adjacent lane may be lane 2. For example, when the current lane is lane 2, the adjacent lanes may be lanes 1 and 3.

Entire lanes may refer to lane 1 to an outermost lane. For instance, on a road including lane 3, the entire lanes may be lane 1, lane 2, and lane 3.

A line may refer to a line that distinguishes between different lanes. For example, if there are four lanes and four lines, line 1 distinguishes the areas of lane 1 and lane 2, line 2 distinguishes the areas of lane 2 and lane 3, line 3 distinguishes the areas of lane 3 and lane 4, and line 4 distinguishes the areas of lane 4 and a shoulder.

The shoulder may refer to a way located at the edge of the road. The shoulder may be a way configured so that a vehicle may be stopped in the event of an emergency or an emergency vehicle (for example, an ambulance or a police car) may move fast. The shoulder used herein may be used as a concept including safe zones such as rest areas, pocket lanes, and preset areas on a road.

The drawings of the present disclosure illustrate the examples of lanes, lines, and shoulders, which are merely examples for understanding. The width, shape, number and type of lanes, lines, and shoulders that may be applied to the apparatus 100 according to an example of the present disclosure are not limited to the drawings.

An automation level of an autonomous driving vehicle may be classified as follows, according to the American Society of Automotive Engineers (SAE). At autonomous driving level 0, the SAE classification standard may correspond to “no automation,” in which an autonomous driving system may be temporarily involved in emergency situations (e.g., automatic emergency braking) and/or may provide warnings only (e.g., blind spot warning, lane departure warning, etc.), and a driver may be expected to operate the vehicle. At autonomous driving level 1, the SAE classification standard may correspond to “driver assistance,” in which the system may perform some driving functions (e.g., steering, acceleration, brake, lane centering, adaptive cruise control, etc.) while the driver may operate the vehicle in a normal operation section, and the driver may be expected to determine an operation state and/or timing of the system, perform other driving functions, and cope with (e.g., resolve) emergency situations. At autonomous driving level 2, the SAE classification standard may correspond to “partial automation,” in which the system may perform steering, acceleration, and/or braking under the supervision of the driver, and the driver may be expected to determine an operation state and/or timing of the system, perform other driving functions, and/or cope with (e.g., resolve) emergency situations. At autonomous driving level 3, the SAE classification standard may correspond to “conditional automation,” in which the system may drive the vehicle (e.g., performs driving functions such as steering, acceleration, and/or braking) under limited conditions but may transfer driving control to the driver when the required conditions are not met, and the driver is expected to determine an operation state and/or timing of the system, and may take over control in emergency situations but do not otherwise operate the vehicle (e.g., steer, accelerate, and/or brake). At autonomous driving level 4, the SAE classification standard may correspond to “high automation,” in which the system may perform all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of lane change control) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of lane change control) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of lane change control) described herein.

Minimum risk maneuver (MRM) operation(s) may also be controlled, for example, based on one or more features (e.g., features of lane change control) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of lane change control) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of lane change control) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

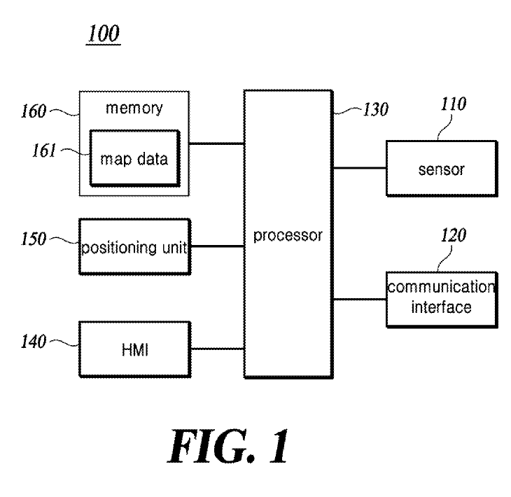

FIG. 1 is a functional block diagram illustrating an apparatus for controlling a lane change of an autonomous vehicle according to an example of the present disclosure.

Referring to FIG. 1, the apparatus 100 for controlling the lane change of the autonomous vehicle according to an example of the present disclosure may include a sensor 110, a communication interface 120, a processor 130, a Human-Machine Interface (HMI) 140, a positioning unit 150, and a memory 160. Components that may be included in the apparatus 100 for controlling the lane change of the autonomous vehicle according to an example of the present disclosure are not limited to FIG. 1. It is possible to further include different components that are not shown in FIG. 1.

The apparatus 100 for controlling the lane change of the autonomous vehicle according to an example of the present disclosure has the effect of enabling efficient driving through the active lane change of a subject vehicle.

The sensor 110 may include at least one sensor. The sensor 110 may be configured to detect an object around the subject vehicle and generate sensor data using at least one sensor. The sensor 110 may include a camera, a LIDAR (light detection and ranging), a RADAR (radio detection and ranging), an ultrasonic sensor, an infrared sensor, etc. The listed sensors are only examples to help understanding, and the sensors of the present disclosure are not limited thereto.

At least one camera may photograph the exterior of the subject vehicle. The type of the camera is not limited. For example, the camera may be an optical camera, a thermal camera, an infrared camera, etc. The camera may capture the surroundings of the subject vehicle and generate sensor data about objects located in front, behind, and to the sides of the subject vehicle.

The LIDAR may use light (or lasers) to generate sensor data about objects located in front, behind, and to the sides of the vehicle.

The RADAR may use electromagnetic waves (or radio waves) to generate sensor data about objects located in front, behind, and to the sides of the vehicle.

The ultrasonic sensor may use ultrasonic waves to generate sensor data about objects located in front, behind, and to the sides of the vehicle. The infrared sensor may use infrared rays to generate sensor data about objects located in front, behind, and to the sides of the vehicle.

The positioning unit 150 may be configured to measure the current location of the subject vehicle. The positioning unit 150 may include at least one of a GPS (Global Positioning System), a DGPS (Differential Global Positioning System), and a GNSS (Global Navigation Satellite System). The positioning unit 150 may be configured to generate the position data of the subject vehicle based on a signal generated by at least one of the GPS, the DGPS, and the GNSS.

The communication interface 120 may be configured to communicate with an external device of the subject vehicle under the control of the processor 130. The communication interface 120 may be configured to collect communication data about the surroundings of the subject vehicle using at least one communication module. The communication interface 120 may collect at least one of V2V-based surrounding vehicle behavior information, I2V-based traffic information, surrounding control system, cloud-based driving-related service, and edge platform-based traffic information. The types of communication data listed are only examples to help understanding, and the communication data of the present disclosure is not limited thereto.

The processor 130 may control each component of the subject vehicle. The processor 130 may control the sensor 110, the communication interface 120, the HMI 140, the positioning unit 150, the memory 160, etc.

The processor 130 monitors a system. Here, the term “system” may mean a method including all or part of processes S230 to S290 described below and/or a device for performing the method. The processor 130 may check whether the system is activated and whether the system is operating normally.

The processor 130 may generate external environment data based on at least one of the sensor data generated by the sensor 110 and the communication data collected by the communication interface 120. For example, the processor 130 may determine weather conditions (heavy rain, heavy snow, thick fog, backlight, temperature, etc.), road conditions (sinkholes, road cracks, black ice, rain, etc.), traffic accident occurrence, traffic congestion, etc. based on the external environment data.

The processor 130 may obtain information about objects around the subject vehicle, such as traffic objects including other vehicles, people, objects, curbs, guardrails, lanes, lines, and obstacles, based on the external environment data. Information about objects around the subject vehicle may include at least one of a position of the object, a size of the object, a shape of the object, a distance to the object, and a relative velocity to the object.

The processor 130 may estimate the behavior of traffic objects within the entire lanes and the density of traffic objects in each lane of the entire lanes based on the external environment data.

The external environment data according to the present disclosure is not limited to the above-described example.

The processor 130 may determine whether a current lane in which the subject vehicle is driving is an optimal lane using at least one of external environment data and pre-stored map data 161.

The map data 161 is stored in the memory 160. The map data 161 may be road-related data or a high definition map. For instance, the map data 161 may include data on road slope, road width, road length, road curvature, road curvature change, etc.

When the processor 130 determines that the current lane in which the subject vehicle is driving is the optimal lane, it may control an autonomous driving controller (not shown) to allow the subject vehicle to maintain the current lane.

When the processor 130 determines that the current lane in which the subject vehicle is driving is not the optimal lane, it may create a lane change strategy including the expected number of lane changes. Even if the system is not activated, the processor 130 may suggest to a user to activate the system when it is determined that the current lane in which the subject vehicle is driving is not the optimal lane.

The processor 130 may determine whether the expected number of lane changes is equal to or less than the maximum allowable number preset by the user. If the processor 130 determines that the expected number of lane changes is equal to or less than the maximum allowable number, it may control the autonomous driving controller to change the lane once based on the created lane change strategy. The processor 130 may control the autonomous driving controller to change lanes once when a lane change command is input by the user into the HMI 140, regardless of whether the current lane is the optimal lane.

The HMI 140 may include a display, a speaker, a haptic device, an input means, etc. The HMI 140 refers to an interface configured to allow the user and the subject vehicle to interact. The user may input a command to control the subject vehicle using the HMI 140. For example, the user may input a command to control the subject vehicle using a button, a touch screen, a voice recognition function, etc. of the HMI 140. The input means of the HMI 140 may include a button, a touch screen, a microphone for voice recognition function, etc.

When the processor 130 determines that the expected number of lane changes exceeds the maximum allowable number, it may control the autonomous driving controller so that the subject vehicle changes lanes once or maintains the current lane based on the lane change strategy created based on the user's permission input into the HMI 140. When a lane change permission command is input into the HMI 140, the processor 130 may control the autonomous driving controller so that the subject vehicle changes lanes once based on the created lane change strategy. When a command prohibiting the lane change is input into the HMI 140, the processor 130 may control the autonomous driving controller so that the subject vehicle maintains the current lane.

When the subject vehicle has changed lanes once, the processor 130 may determine whether the subject vehicle has changed lanes as many times as the number of lane changes specified in the calculated lane change strategy. When it is determined that the subject vehicle has not changed lanes as many times as the number of lane changes, the processor 130 may determine whether the lane change strategy is valid in the changed current lane. This is because the lane that serves as the basis for collecting sensor data in the changed current lane changes, and external environment data may change as time passes while the subject vehicle changes lanes once. When the processor 130 determines that the lane change strategy is valid in the changed current lane, it may control the autonomous driving controller to allow the subject vehicle to further change the lane once based on the lane change strategy.

When the processor 130 determines that the lane change strategy is not valid in the changed current lane, it may determine whether the changed current lane in which the subject vehicle is driving is an optimal lane.

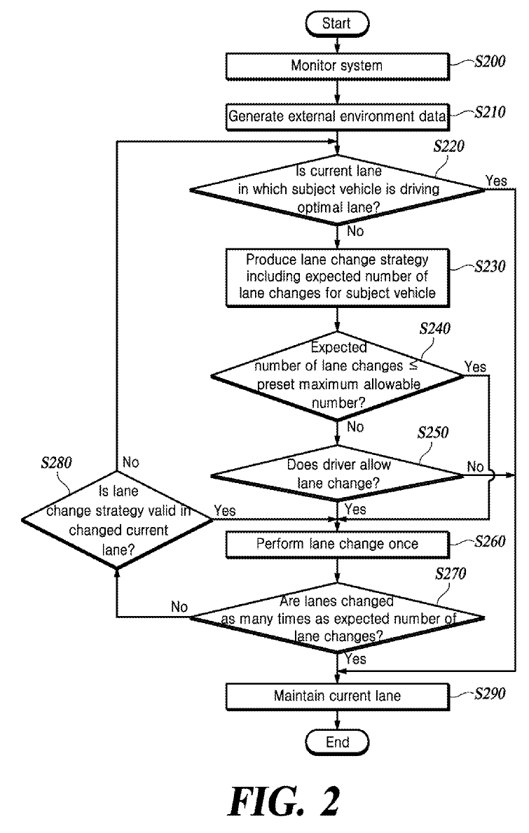

FIG. 2 is a flowchart illustrating a method for controlling a lane change of an autonomous vehicle.

FIG. 3 is a detailed step flowchart of S220.

Referring to FIGS. 2 and 3, the apparatus 100 for controlling the lane change of the autonomous vehicle may perform processes S200 to S290 when controlling the subject vehicle to maintain the current lane in which the subject vehicle is driving or to change lanes for efficient driving of the subject vehicle.

The apparatus 100 for controlling the lane change of the autonomous vehicle monitors the system at S200. The apparatus 100 for controlling the lane change of the autonomous vehicle may check whether the system is activated and whether the system is operating normally.

The apparatus 100 for controlling the lane change of the autonomous vehicle may generate external environment data at S210. The apparatus 100 for controlling the lane change of the autonomous vehicle may generate external environment data based on at least one of the sensor data generated by the sensor 110 and the communication data collected by the communication interface 120. Here, the communication data collected by the communication interface 120 may include at least one of V2V-based surrounding vehicle behavior information, I2V-based infrastructure traffic information, traffic flow and control-related information for a surrounding control system, traffic flow information for a cloud-based driving-related service, and traffic information by road section based on edge platform. However, the present disclosure is not necessarily limited thereto.

The apparatus 100 for controlling the lane change of the autonomous vehicle may estimate the behavior of traffic objects within the entire lane using external environment data. Here, the traffic objects within the entire lane may include traffic objects within the range of 1 km in front of the subject vehicle. However, the present disclosure is not necessarily limited thereto and may be changed depending on the user's settings, etc.

The apparatus 100 for controlling the lane change of the autonomous vehicle may estimate the density of traffic objects for each lane in the entire lanes using the external environment data. The traffic object density may be classified into smooth traffic flow, cluster traffic flow, and/or congested traffic flow.

FIGS. 4A, 4B, and 4C are diagrams showing the density of traffic objects in a lane.

FIG. 4A is a diagram showing a smooth traffic flow.

FIG. 4B is a diagram showing a cluster traffic flow.

FIG. 4C is a diagram showing a congested traffic flow.

Referring to FIGS. 4A to 4C, the number of traffic objects within a unit section lane increases in the order of the smooth traffic flow, the cluster traffic flow, and the congested traffic flow. Here, the unit section lane may refer to a lane of the same section and length. The smooth traffic flow, cluster traffic flow, and congested traffic flow may be relative concepts. Therefore, it might not be necessarily limited to the number of traffic objects shown in FIGS. 4A to 4C. For example, if the average driving speed of the current lane is lower than the average driving speed of the surrounding lane by at least a user–defined lane-to-lane average speed difference, the current lane may be estimated as a congested traffic flow. Here, the surrounding lane may mean lanes other than the current lane in the entire lanes. The average driving speed difference between preset lanes may be, for example, 20 km/h. However, the present disclosure is not necessarily limited thereto and may be changed depending on the user's settings, etc.

Further, the length of the unit section lane and the density of traffic objects may be changed depending on the user's settings, etc.

The apparatus 100 for controlling the lane change of the autonomous vehicle uses external environment data to determine whether the current lane in which the subject vehicle is driving is the optimal lane, at S220. The apparatus 100 for controlling the lane change of the autonomous vehicle may determine whether the current lane in which the subject vehicle is driving is the optimal lane by considering at least one of lane change regulations in the road, traffic signs, and external environment data. Examples of the lane change restrictions in the road may include solid lanes where lane changes are not permitted, inside tunnels, shoulders, or bus-only lanes. Examples of the traffic signs may include signs indicating lane reduction due to merging, a sharp curve ahead, and a construction zone. However, the lane change regulations and traffic signs in the road are not necessarily limited to the examples.

The apparatus 100 for controlling the lane change of the autonomous vehicle determines whether a vehicle in front of the subject vehicle is not a vehicle that obstructs the traffic flow, at S310.

Here, the vehicle that obstructs the traffic flow refers to a vehicle in front of the subject vehicle that meets at least one of the following conditions: it is driving at an average speed lower than the average speed of the surrounding lane by at least a preset inter-lane speed difference; it repeatedly performs sudden braking and rapid acceleration; it repeatedly moves laterally within the lane; it is flashing a hazard light; or it is transmitting an emergency message. However, this is merely illustrative and may be changed depending on the user's settings, etc. without being necessarily limited thereto. Here, the preset average speed difference between the lanes may be, for example, 20 km/h. However, the present disclosure is not necessarily limited thereto and may be changed depending on the user's settings, etc.

When the apparatus 100 for controlling the lane change of the autonomous vehicle determines that the vehicle in front of the subject vehicle is a vehicle that obstructs the traffic flow, it may determine that the current lane in which the subject vehicle is driving is not the optimal lane.

When the apparatus 100 for controlling the lane change of the autonomous vehicle determines that the vehicle in front of the subject vehicle is not the vehicle that obstructs the traffic flow, it may determine whether the current lane in which the subject vehicle is driving is one in which traffic flow is smooth, at S320.

When the apparatus 100 for controlling the lane change of the autonomous vehicle determines that the current lane in which the subject vehicle is driving is one in which traffic flow is smooth, it may determine that the current lane in which the subject vehicle is driving is the optimal lane.

When the apparatus 100 for controlling the lane change of the autonomous vehicle determines that the current lane in which the subject vehicle is driving is not in a smooth traffic flow, it determines whether the surrounding lane is not in the smooth traffic flow, at S330.

When the apparatus 100 for controlling the lane change of the autonomous vehicle determines that the surrounding lane is not in the smooth traffic flow, it may determine that the current lane in which the subject vehicle is driving is the optimal lane. In this case, it may indicate that the entire lanes, including the current lane in which the subject vehicle is driving, are not in the smooth traffic flow, making it impossible to achieve optimal driving through the lane change.

When the apparatus 100 for controlling the lane change of the autonomous vehicle determines that the current lane in which the subject vehicle is driving is not in the smooth traffic flow and the surrounding lane is in the smooth traffic flow, it may determine that the current lane in which the subject vehicle is driving is not the optimal lane.

When the apparatus 100 for controlling the lane change of the autonomous vehicle determines that the current lane in which the subject vehicle is driving is the optimal lane, the apparatus may control the autonomous driving controller so that the subject vehicle maintains the current lane, at S290.

When the apparatus 100 for controlling the lane change of the autonomous vehicle determines that the current lane in which the subject vehicle is driving is not the optimal lane, it may create the lane change strategy that includes the expected number of lane changes for the subject vehicle, at S230.

The lane change strategy may include a transit lane, a final destination lane, and the expected number of lane changes. The lane change strategy may be created by considering lane change regulations in the road, traffic signs, and external environment data. Examples of the lane change restrictions in the road may include solid lanes where lane changes are not permitted, inside tunnels, shoulders, and/or bus-only lanes. Examples of the traffic signs may include signs indicating lane reduction due to merging, a sharp curve ahead, and a construction zone. However, the lane change regulations and traffic signs in the road are not necessarily limited to the examples.

The expected number of lane changes may refer to the number of lane changes that occur when all lane change strategies are executed. For example, if the subject vehicle changes lanes from lane 3 to lane 1, the transit lane is lane 2, the final destination lane is lane 1, and the expected number of lane changes is 2. When the subject vehicle changes lanes from lane 2 to lane 1 and then returns to lane 2, the transit lane is lane 1, the final destination lane is lane 2, and the expected number of lane changes is 2.

The apparatus 100 for controlling the lane change of the autonomous vehicle may determine whether the number of lane changes expected in the created lane change strategy is less than or equal to the maximum allowable number preset by the user, at S240. Here, the preset maximum allowable number may refer to the number of lane changes set by the user. By setting the maximum allowable number, it may reflect the user’s driving preference.

When it is determined that the expected number of lane changes is equal to or less than the maximum allowable number, the apparatus 100 for controlling the lane change of the autonomous vehicle may control the autonomous driving controller so that the subject vehicle changes lanes once, at S260.

When it is determined that the expected number of lane changes exceeds the maximum allowable number, the apparatus 100 for controlling the lane change of the autonomous vehicle may determine whether the user is allowed to change lanes, at S250.

When it is determined that the user is allowed to change lanes, the apparatus 100 for controlling the lane change of the autonomous vehicle may control the autonomous driving controller so that the subject vehicle changes lanes once, at S260.

When it is determined that the user is not allowed to change lanes, the apparatus 100 for controlling the lane change of the autonomous vehicle controls the autonomous driving controller so that the subject vehicle maintains the current lane, at S290.

When the subject vehicle changes lanes once, the apparatus 100 for controlling the lane change of the autonomous vehicle may determine whether the subject vehicle has changed lanes as many times as the number of lane changes specified in the calculated lane change strategy, at S270.

When it is determined that the subject vehicle has changed lanes as many times as the number of lane changes, the apparatus 100 for controlling the lane change of the autonomous vehicle may control the autonomous driving controller so that the subject vehicle maintains the current lane, at S290.

When it is determined that the subject vehicle has not changed lanes as many times as the number of lane changes, the apparatus 100 for controlling the lane change of the autonomous vehicle may determine whether the lane change strategy is valid in the changed current lane, at S280. When the subject vehicle changes the lane once, the lane serving as the basis for collecting sensor data of the sensor 110 may be changed. Further, as time passes while the subject vehicle changes lanes once, there may be a change in external environment data, such as the behavior of traffic objects around the subject vehicle. In this case, it may be impossible to perform the lane change strategy in the changed current lane, or it may be impossible to achieve optimal driving by performing the lane change strategy.

When it is determined that the lane change strategy is valid in the changed current lane, the apparatus 100 for controlling the lane change of the autonomous vehicle may control the autonomous driving controller to allow the subject vehicle to further change the lane once based on the lane change strategy, at S260. For instance, when the generated lane change strategy is a strategy for changing lanes from lane 3 to lane 1 and it is determined that the lane change strategy is effective in lane 2, which is the changed current lane, the apparatus 100 for controlling the lane change of the autonomous vehicle may control the autonomous driving controller so that the subject vehicle changes lanes to lane 1.

When it is determined that the lane change strategy is not valid in the changed current lane, the apparatus 100 for controlling the lane change of the autonomous vehicle may determine whether the current lane in which the subject vehicle is driving is the optimal lane, at S220.

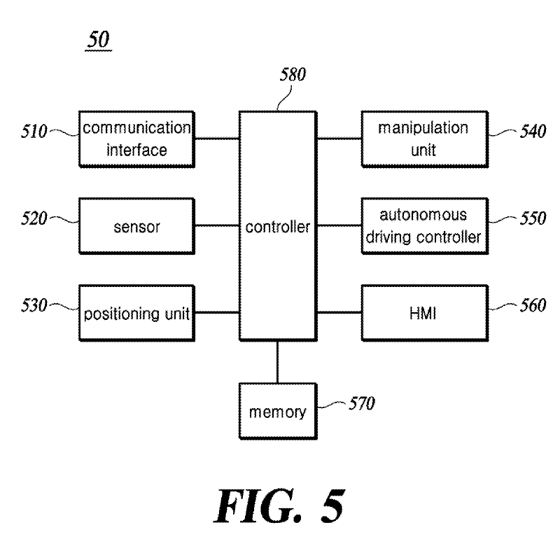

FIG. 5 is a block diagram schematically showing an exemplary vehicle system that may be used to implement a method or apparatus described in the present disclosure.

Referring to FIG. 5, the vehicle 50 includes at least one of a communication interface 510, a sensor 520, a positioning unit 530, a manipulation unit 540, an autonomous driving controller 550, an HMI 560, a memory 570, and a controller 580. The vehicle 50 may structurally and/or functionally include the control apparatus 100.

The communication interface 510 may exchange signals with devices located outside and inside the vehicle 50. The communication interface 510 may exchange signals with at least one of an infrastructure device such as a server or a base station, another vehicle, and a terminal. The communication interface 510 may include at least one of a transmitting antenna, a receiving antenna, an RF (Radio Frequency) circuit capable of implementing various communication protocols, and/or an RF element to perform communication. The communication interface 510 may include an internal communication interface and an external communication interface. The internal communication interface may transmit or receive signals using various communication protocols existing within the vehicle 50. Here, the internal communication protocol may include at least one of CAN (Controller Area Network), CAN FD (CAN with Flexible Data rate), Ethernet, LIN (Local Interconnect Network), and FlexRay. The communication protocol may include other protocols for communication between various devices mounted on the vehicle. The external communications unit may communicate with other vehicles, infrastructure systems, base stations, roadside equipment, etc. using various communication protocols. Here, the external communication protocol may include vehicle-to-vehicle (V2V) communication, vehicle-to-infrastructure (V2I) communication, vehicle-to-network (V2N) communication, and vehicle-to-everything (V2X) communication including vehicle-to-pedestrian communication. The infrastructure may comprise a roadside unit or server that periodically transmits traffic information in conjunction with, for example, a Transportation Information System (TIS) or an Intelligent Transport System (ITS).

The sensor 520 may sense the status of the vehicle 50 and external objects. The sensor 520 may include at least one of an IMU (inertial measurement unit), a DMI (distance measuring instrument) device, a collision sensor, a wheel sensor, a speed sensor, an inclination sensor, a weight detection sensor, a heading sensor, a position module, a vehicle forward/backward sensor, a battery sensor, a fuel sensor, a tire sensor, a steering sensor, a temperature sensor, a humidity sensor, an ultrasonic sensor, a luminance sensor, and a pedal position sensor to sense the status of the vehicle 50. Meanwhile, the IMU sensor may include one or more of an acceleration sensor, a gyro sensor, and/or a magnetic sensor. The sensor 520 may generate vehicle status data, based on a signal generated from at least one sensor. For example, direction information such as heading and yaw rate of the vehicle 50 may be collected by the sensor 520.

The sensor 520 may include at least one of a camera, a radar sensor, a Light Detection and Ranging (LiDAR) sensor, an ultrasonic sensor, and/or an infrared sensor to detect external objects. The sensor 520 may measure at least one of information on the presence or absence of an object, information on the position of the object, information on the distance between the vehicle 50 and the object, and information on relative speed between the vehicle 50 and the object.

The positioning unit 530 may generate location data of the vehicle 50. The positioning unit 530 may include at least one of a Global Positioning System (GPS), a Differential Global Positioning System (DGPS), or a Global Navigation Satellite System (GNSS). The positioning unit 530 may generate location data of the vehicle 50 based on a signal generated from at least one of the GPS, DGPS, or GNSS. The positioning unit 530 may estimate the location of the vehicle 50 based on wireless signals received from the communication interface 510. The positioning unit 530 may estimate the current location of the vehicle 50 based on the previous position, moving distance information, moving time information, speed information, or acceleration information of the vehicle 50 using an IMU or DMI. Meanwhile, based on the location information of the vehicle 50 collected by the positioning unit 530, the controller 580 may estimate the path history and predicted path of thevehicle 50.

The manipulation unit 540 receives user input for driving. In the manual mode, the vehicle 50 may be driven based on a signal provided by the manipulation unit 540. The manipulation unit 540 may include a steering input device such as a steering wheel, an acceleration input device such as an accelerator pedal, and a brake input device such as a brake pedal.

The autonomous driving controller 550 may be a device that electrically controls various vehicle driving devices within the vehicle 50. The autonomous driving controller 550 may include a powertrain driving control device, a chassis driving control device, a door/window driving control device, a safety device driving control device, a lamp driving control device, and/or an air conditioning driving control device. The autonomous driving controller 550 may control the movement of the vehicle 50 based on an input signal of the manipulation unit 540 or a control signal of the controller 580.

The HMI 560 is a device for communication between the vehicle 50 and a person (e.g., a passenger of the vehicle 50 or another vehicle). The HMI 560 may receive input from a user and provide information generated in the vehicle 50 to the user. The vehicle 50 may implement a UI (User Interface) or UX (User Experience) using the HMI 560. The HMI 560 may include input devices such as a touch panel, a microphone, etc., and may include output devices such as a display device, a speaker, etc. For example, the HMI 560 may include an internal display that outputs a screen toward the inside of the vehicle and/or an external display that outputs the screen toward the outside of the vehicle.

The memory 570 may store a program that causes the controller 580 to perform a method according to an example of the present disclosure. For example, the program may include a plurality of commands executable by the processor, and a method according to an example of the present disclosure may be performed by executing the plurality of commands using the processor.

The memory 570 may be a single memory or multiple memories. If the memory 570 is composed of the multiple memories, the multiple memories may be physically separated. The memory 570 may include at least one of volatile memory and non-volatile memory. The volatile memory includes SRAM (Static Random-Access Memory) or DRAM (Dynamic Random-Access Memory), and the non-volatile memory includes flash memory.

The memory 570 may store map information. The map information may be either a navigation map and/or a high-definition map (HD map). The HD map may be received from the external device or may be stored in advance. The navigation map may include geographic information, road information, lane information, building information, or signal information. The HD map contains more specific data than the navigation map. The HD map may include, at the road level, information such as road slopes, road curvature, and traffic signs. The HD map may include, at the lane level, lane information, lane boundary information, stop line locations, traffic light locations, signal sequences, or intersection information. The HD map may include basic road information, surrounding environment information, detailed road environment information, or dynamic road condition information. The detailed road environment information may include static information such as terrain elevation, curvature, lines, lane centerlines, regulatory lines, road boundaries, road centerlines, traffic signs, road markings, road shape and height, and lane width. The dynamic road condition information may include traffic congestion, accident zones, and construction zones. The HD map may include information about the surrounding road environment implemented in 3D, geometric information such as road shape or facility structure, and semantic information such as traffic signs or line marks.

The controller 580 may include at least one core capable of executing at least one command. The controller 580 may execute commands stored in the memory 570. The controller 580 may be a single processor or multiple processors.

Each component of the apparatus or method according to the present disclosure may be implemented by hardware or software, or may be implemented by a combination of hardware and software. In addition, a function of each component may be implemented in software, and a microprocessor may be implemented to execute a function of the software corresponding to each component.

Various implementations of systems and techniques described herein may be realized as digital electronic circuits, integrated circuits, field programmable gate arrays (FPGAs), application specific integrated circuits (ASICs), computer hardware, firmware, software, and/or combinations thereof. These various implementations may include one or more computer programs executable on a programmable system. The programmable system includes at least one programmable processor (which may be a special-purpose processor or a general-purpose processor) coupled to receive and transmit data and instructions from and to a storage system, at least one input device, and at least one output device. The computer programs (also known as programs, software, software applications or codes) may contain commands for a programmable processor and are stored in a "computer-readable recording medium".

The computer-readable recording medium may include all types of recording devices in which data readable by a computer system is stored. Such a computer-readable recording medium may be a non-volatile or non-transitory medium, such as ROM, CD-ROM, magnetic tape, floppy disk, memory card, hard disk, magneto-optical disk, or a storage device, and may further include a transitory medium such as a data transmission medium. In addition, the computer-readable recording medium may be distributed in a computer system connected via a network, so that computer-readable codes may be stored and executed in a distributed manner.

Various implementations of systems and techniques described herein may be embodied by a programmable computer. Here, the computer includes a programmable processor, a data storage system (including volatile memory, non-volatile memory, or other types of storage systems, or combinations thereof) and at least one communication interface. For example, the programmable computer may be one of a server, a network device, a set top box, an embedded device, a computer expansion module, a personal computer, a laptop, a personal data assistant (PDA), a cloud computing system, and/or a mobile device.

Although examples of the present disclosure have been described for illustrative purposes, those having ordinary skill in the art should appreciate that various modifications, additions, and substitutions are possible, without departing from the idea and scope of the present disclosure. Therefore, examples of the present disclosure have been described for the sake of brevity and clarity. The scope of the technical idea of the present examples is not limited by the illustrations. Accordingly, one of ordinary skill should understand that the scope of the present disclosure should not be limited by the above explicitly described examples but by the claims and equivalents thereof.

What is claimed is:

1. An apparatus for an autonomous vehicle, the apparatus comprising:
a sensor configured to detect an object around the autonomous vehicle;
a communication interface configured to communicate with an external device; and
a processor configured to control an autonomous driving controller,
wherein the processor is configured to:
generate, based on at least one of sensor data generated by the sensor and communication data collected by the communication interface, external environment data;
determine, using the external environment data, whether a current lane in which the autonomous vehicle is driving is an optimal lane;
create, based on determining that the current lane in which the autonomous vehicle is driving is not the optimal lane, a lane change strategy including an expected number of lane changes;
cause, based on the lane change strategy, the autonomous driving controller to control the autonomous vehicle to change a lane once and move to a changed current lane;
determine whether the autonomous vehicle has changed lanes as many times as the expected number of lane changes;
determine, based on determining that the autonomous vehicle has not changed lanes as many times as the expected number of lane changes, whether the lane change strategy is valid in the changed current lane; and
cause, based on whether the lane change strategy is valid in the changed current lane, the autonomous driving controller to control autonomous driving of the autonomous vehicle.

2. The apparatus of claim 1, wherein the processor is further configured to:
determine, based on the lane change strategy corresponding to a discretionary lane change, whether the expected number of lane changes is equal to or less than a maximum allowable number preset by a user; and
cause, based on determining that the expected number of lane changes is equal to or less than the maximum allowable number, the autonomous driving controller to control the autonomous vehicle to change the lane once based on the lane change strategy.

3. The apparatus of claim 1, wherein the processor is further configured to:
cause, based on determining that the autonomous vehicle has changed lanes as many times as the expected number of lane changes, the autonomous vehicle to maintain the changed current lane.

4. The apparatus of claim 1, wherein the processor is further configured to:
cause, based on determining that the lane change strategy is valid in the changed current lane, the autonomous driving controller to control the autonomous vehicle to additionally change the changed current lane based on the lane change strategy.

5. The apparatus of claim 1, wherein the processor is further configured to:
determine, based on determining that the lane change strategy is not valid in the changed current lane, whether the changed current lane is an optimal lane.

6. The apparatus of claim 1, wherein the processor is configured to determine whether the current lane in which the autonomous vehicle is driving is an optimal lane by determining whether the current lane in which the autonomous vehicle is driving is in a smooth traffic flow.

7. The apparatus of claim 6, wherein the processor is further configured to:
determine, based on determining that an average driving speed of the current lane in which the autonomous vehicle is driving is lower than an average driving speed of a surrounding lane of the autonomous vehicle by at least a preset average driving speed difference between lanes, that the current lane in which the autonomous vehicle is driving is not in the smooth traffic flow.

8. The apparatus of claim 6, wherein the processor is further configured to:
determine, based on determining that the current lane in which the autonomous vehicle is driving is not in the smooth traffic flow, whether a surrounding lane of the autonomous vehicle is in a smooth traffic flow, and
create, based on determining that the surrounding lane of the autonomous vehicle is in a smooth traffic flow, the lane change strategy.

9. The apparatus of claim 1, wherein the processor is further configured to:
determine whether a vehicle in front of the autonomous vehicle is a vehicle that obstructs a traffic flow; and
create, based on determining that the vehicle in front of the autonomous vehicle is the vehicle that obstructs the traffic flow, the lane change strategy.

10. The apparatus of claim 1, wherein the processor is further configured to:
determine whether a vehicle in front of the autonomous vehicle is a vehicle that obstructs a traffic flow;
determine, based on determining that the vehicle in front of the autonomous vehicle is the vehicle that obstructs the traffic flow, whether a surrounding lane of the autonomous vehicle is in a smooth traffic flow; and
create, based on determining that the surrounding lane of the autonomous vehicle is in a smooth traffic flow, the lane change strategy.

11. The apparatus of claim 1, wherein the communication interface is configured to collect at least one of vehicle-to-vehicle (V2V)-based surrounding vehicle behavior information, infrastructure-to-vehicle (I2V)-based traffic information, surrounding control system, cloud-based driving-related service, or edge platform-based traffic information.

12. The apparatus of claim 1, wherein the processor is configured to determine whether the current lane in which the autonomous vehicle is driving is the optimal lane based on at least one of:
surrounding objects of the autonomous vehicle,
lane change regulations in a road,
traffic signs, or
the external environment data.

13. A method performed by an autonomous vehicle, the method comprising:
generating, based on at least one of sensor data generated by a sensor of the autonomous vehicle and communication data collected by a communication interface of the autonomous vehicle, external environment data;
determining, using the external environment data, whether a current lane in which the autonomous vehicle is driving is an optimal lane;
creating, based on determining that the current lane in which the autonomous vehicle is driving is not the optimal lane, a lane change strategy including an expected number of lane changes;
causing, based on the lane change strategy, an autonomous driving controller of the autonomous vehicle to control the autonomous vehicle to change a lane once and move to a changed current lane;
determining whether the autonomous vehicle has changed lanes as many times as the expected number of lane changes;
determining, based on determining that the autonomous vehicle has not changed lanes as many times as the expected number of lane changes, whether the lane change strategy is valid in the changed current lane; and
causing, based on whether the lane change strategy is valid in the changed current lane, the autonomous driving controller to control autonomous driving of the autonomous vehicle.

14. The method of claim 13, further comprising:
after creating the lane change strategy including the expected number of lane changes, determining, based on the lane change strategy corresponding to a discretionary lane change, whether the expected number of lane changes is equal to or less than a maximum allowable number preset by a user,
wherein the causing the autonomous driving controller to control the autonomous vehicle to change the lane once comprises causing the autonomous driving controller to control the autonomous vehicle to change the lane once based on determining that the expected number of lane changes is equal to or less than the maximum allowable number.

15. The method of claim 13, further comprising:
based on determining that the autonomous vehicle has changed lanes as many times as the expected number of lane changes, causing the autonomous vehicle to maintain the changed current lane.

16. The method of claim 13, further comprising:
causing, based on determining that the lane change strategy is valid in the changed current lane, the autonomous driving controller to control the autonomous vehicle to additionally change the changed current lane based on the lane change strategy.

17. The method of claim 13, further comprising:
based on determining that the lane change strategy is not valid in the changed current lane, determining whether the changed current lane is an optimal lane.

18. The method of claim 13, wherein determining whether the current lane in which the autonomous vehicle is driving is the optimal lane comprises:
determining whether the current lane in which the autonomous vehicle is driving is in a smooth traffic flow.

19. The method of claim 18, wherein the determining whether the current lane in which the autonomous vehicle is driving is the optimal lane comprises:
determining, based on determining that the current lane in which the autonomous vehicle is driving is not in the smooth traffic flow, whether a surrounding lane of the autonomous vehicle is in the smooth traffic flow; or
creating, based on determining that that the surrounding lane of the autonomous vehicle is in the smooth traffic flow, the lane change strategy.

20. The method of claim 13, wherein the determining whether the autonomous vehicle is driving on the optimal lane comprises:
determining whether a vehicle in front of the autonomous vehicle is a vehicle that obstructs a traffic flow; and
creating, based on determining that the vehicle in front of the autonomous vehicle is the vehicle that obstructs the traffic flow, the lane change strategy.
